(19) United States
(12) Patent Application Publication
(10) Pub. No.: US 2022/0227943 A1
(43) Pub. Date: Jul. 21, 2022

(54) Polyamideimide Resin, and Polyamideimide Film and Window Cover Film Including the Same

(71) Applicants: SK Innovation Co., Ltd., Seoul (KR); SK ie technology Co., Ltd., Seoul (KR)

(72) Inventors: Hye Ri Kim, Daejeon (KR); Seung Min Jeon, Daejeon (KR); Jin Hyung Park, Daejeon (KR)

(21) Appl. No.: 17/575,741

(22) Filed: Jan. 14, 2022

(30) Foreign Application Priority Data
Jan. 15, 2021 (KR) 10-2021-0006050
Jan. 4, 2022 (KR) 10-2022-0001086

(51) Int. Cl. C08G 73/14; C08G 73/10; C08L 79/08

(52) U.S. Cl. CPC C08G 73/14; C08G 73/1007; C08G 73/1039; C08G 73/1042; C08G 73/1053; C08L 2203/206; C08L 79/08; C08G 2150/00; C08L 2201/10; C08L 2203/16; C08G 73/1075

(57) ABSTRACT

Provided are a polyamideimide resin, and a polyamideimide film and a window cover film including the same. More particularly, a polyamideimide resin for preparing a polyamideimide film which satisfies both optical properties and mechanical properties which are in a trade-off relationship with each other and has more improved mechanical properties than a conventional polyamideimide film, a polyamideimide film using the same, and a window cover film including the same are provided.

### CROSS-REFERENCE TO RELATED APPLICATIONS

This application claims priority to Korean Patent Application Nos. 10-2021-0006050 filed Jan. 15, 2021 and 10-2022-0001086 filed Jan. 4, 2022, the disclosures of which are hereby incorporated by reference in their entirety.

### BACKGROUND OF THE INVENTION

### Field of the Invention

The following disclosure relates to a polyamideimide resin, and a polyamideimide film and a window cover film including the same. More particularly, the following disclosure relates to a polyamideimide resin for preparing a polyamideimide film which satisfies both optical properties and mechanical properties which are in a trade-off relationship with each other and has more improved mechanical properties than a conventional polyamideimide film, a polyamideimide film using the same, and a window cover film including the same.

### Description of Related Art

A thin display device is implemented in a touch screen panel form and is used in various smart devices including smart phones, tablet PCs, and various wearable devices.

Display devices using the touch screen panel are provided with a window cover including a tempered glass or a plastic film on a display panel in order to protect the display panel from scratches or external impact.

Since the window cover is a configuration formed in the outermost part of a display device, thermal resistance, mechanical properties, and optical properties should be satisfied, and, in particular, it is important that display quality is high and light distortion such as a Mura phenomenon and image distortion does not occur.

As a polymer material applied to the window cover film, a polyimide-based resin and the like are used, and in order to apply the polymer to a foldable display and the like, improvement of mechanical properties is required, but when a monomer having a rigid structure is used in a large amount for improving mechanical properties, optical properties such as a yellow index and a light transmittance are deteriorated, and thus, there was a difficulty in satisfying both optical properties and mechanical properties.

However, in order to apply the film as a window cover film of a flexible display, development of a film which satisfies both mechanical properties and optical properties is still needed, together with continuous development of a flexible display.

### SUMMARY OF INVENTION

### Technical Problem

An embodiment of the present invention is directed to providing a polyamideimide resin which has excellent mechanical properties such as high strength and high impact resistance and also excellent optical properties such as a high total light transmittance and a low yellow index so that the resin may be applied to a window cover film for replacing a window cover glass for a display and a polyamideimide film using the same.

In particular, an embodiment of the present invention is directed to providing a polyamideimide resin and a polyamideimide film which satisfy both improved mechanical properties and improved optical properties as compared with a conventionally developed polyamideimide film.

Another embodiment of the present invention is directed to providing a new window cover film which satisfies excellent mechanical properties, thermal properties, and various optical properties, and also may solve problems such as distortion by light, thereby replacing tempered glass.

### Solution to Problem

In one general aspect, a polyamideimide resin includes: a structural unit derived from an aromatic diamine, a structural unit derived from an aromatic diacid dichloride, and a structural unit derived from a dianhydride,

wherein the aromatic diamine includes a compound represented by the following Chemical Formula 1, and

the aromatic diacid dichloride includes terephthaloyl dichloride:

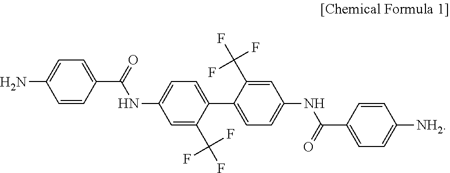 [SMILES: Nc1ccc(C(=O)Nc2ccc(-c3ccc(NC(=O)c4ccc(N)cc4)cc3C(F)(F)F)c(C(F)(F)F)c2)cc1]

In an exemplary embodiment, the aromatic diamine may further include a second aromatic diamine which is different from the compound represented by Chemical Formula 1.

In an exemplary embodiment, the second aromatic diamine may include an aromatic ring substituted with a trifluoroalkyl group.

In an exemplary embodiment, the second aromatic diamine may include 2,2′-bis(trifluoromethyl)-benzidine.

In an exemplary embodiment, the dianhydride may include any one or two or more selected from the group consisting of aromatic dianhydrides and cycloaliphatic dianhydrides.

In an exemplary embodiment, the dianhydride may include one or two or more aromatic dianhydrides and one or two or more cycloaliphatic dianhydrides.

In an exemplary embodiment, the aromatic dianhydride may include 4,4′-hexafluoroisopropylidene diphthalic anhydride, biphenyltetracarboxylic dianhydride, or a combination thereof.

In an exemplary embodiment, the cycloaliphatic dianhydride may include 1,2,3,4-cyclobutanetetracarboxylic dianhydride.

In an exemplary embodiment, the structural unit derived from the compound represented by Chemical Formula 1 may be included at mol % or less, based on total moles of the structural unit derived from the aromatic diamine.

In an exemplary embodiment, the structural unit derived from the aromatic diacid dichloride may be included at 50 mol % or more, based on 100 moles of the structural unit derived from the aromatic diamine.

In an exemplary embodiment, an equivalent ratio of the structural unit derived from the aromatic diamine to a sum of the structural unit derived from the aromatic diacid dichloride and the structural unit derived from the dianhydride may be 1:0.9 to 1.1.

In an exemplary embodiment, the polyamideimide resin may have a weight average molecular weight of 200,000 g/mol or more.

In another general aspect, a polyamideimide resin composition includes the polyamideimide resin according to the above exemplary embodiment.

In another general aspect, a polyamideimide film includes the polyamideimide resin according to the above exemplary embodiment.

In an exemplary embodiment, the polyamideimide film may have a modulus of 6 GPa or more.

In an exemplary embodiment, the polyamideimide film may have a total light transmittance of 87% or more as measured at a wavelength of 400 to 700 nm in accordance with ASTM D1003, a haze in accordance with ASTM D1003 of 2.0% or less, and a yellow index in accordance with ASTM E313 of 5 or less.

In an exemplary embodiment, the polyamideimide film may have a thickness of 1 to 500 μm.

In another general aspect, a window cover film includes the polyamideimide resin or the polyamideimide film according to the above exemplary embodiment.

In an exemplary embodiment of the present invention, the window cover film may have any one or more coating layers selected from a hard coating layer, an antistatic layer, an anti-fingerprint layer, an antifouling layer, an anti-scratch layer, a low-refractive layer, an anti-reflective layer, and shock absorption layer on at least one surface of the polyamideimide film.

In still another general aspect, a flexible display panel includes the polyamideimide film according to the above exemplary embodiment.

### Advantageous Effects

The polyamideimide resin according to an exemplary embodiment and the polyamideimide film using the same have both excellent mechanical properties and excellent optical properties, and thus, may be applied to a window cover film replacing a cover glass for a display.

In addition, since the polyamideimide film may provide better mechanical properties than a conventional polyamideimide film, it may provide a high-strength window cover film made of rollable and flexible materials.

### DESCRIPTION OF THE INVENTION

Hereinafter, an exemplary embodiment of the present invention will be described in detail. However, the present invention may be implemented in various types, and is not limited to the exemplary embodiments described herein.

In addition, the technical and scientific terms used in the description of the invention have, unless otherwise defined, the meaning commonly understood by those of ordinary skill in the art. In the present specification, unless otherwise stated in the text, a singular form also includes a plural form.

Throughout the present specification describing the present invention, unless explicitly described to the contrary, “comprising” any elements will be understood to imply further inclusion of other elements rather than the exclusion of any other elements.

Hereinafter, unless otherwise defined in the present specification, it will be understood that when an element such as a layer, a film, a thin film, a region, or a substrate is referred to as being “on” or “above” another element, it can be directly on the other element or intervening elements may also be present.

Hereinafter, unless otherwise defined in the present specification, a “combination thereof” refers to a mixture or copolymer of constituent elements.

Hereinafter, unless otherwise defined in the present specification, “substituted” refers to a hydrogen atom in a compound being substituted with a substituent, and for example, the substituent may be selected from deuterium, halogen atoms (F, Br, Cl, or I), a hydroxyl group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C30 alkyl group, a C2 to C30 alkenyl group, a C2 to C30 alkynyl group, a C6 to C30 aryl group, a C7 to C30 arylalkyl group, a C1 to C30 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C30 heterocyclic group, and a combination thereof.

Hereinafter, unless otherwise defined in the present specification, a resin includes a homopolymer and a copolymer, and the copolymer includes an alternating polymer, a block copolymer, a random copolymer, a branched copolymer, a crosslinked copolymer, or all of them.

Hereinafter, unless otherwise defined in the present specification, a polyamide resin refers to a resin having a structural unit having an amide bond, and a polyamideimide resin refers to a resin having a structural unit having an amide bond and a structural unit having an imide bond.

Hereinafter, the polyamideimide resin according to an exemplary embodiment will be described.

Conventionally, in order to increase the mechanical properties of a polyimide film or a polyamideimide film, a polyimide resin or a polyamideimide resin having a structural unit derived from a compound having a rigid structure were used. However, accordingly, closeness between resins is increased to increase a retardation (Rₜₕ) in a thickness direction in forming a film to cause distortion when applying the film to a display and the like, and optical properties are deteriorated, for example, a total light transmittance is decreased and a yellow index is greatly increased. Thus, a polyamideimide resin which may impart both excellent mechanical properties and excellent optical properties is needed.

As a result of studying for improving the situation, the inventors of the present invention confirmed that the problem may be solved by using compounds having structures specified by an aromatic diamine and an aromatic diacid dichloride together.

More specifically, the aromatic diamine may include a compound represented by the following Chemical Formula 1 (hereinafter, also referred to as AB-TFMB), and the aromatic diacid dichloride may include terephthaloyl dichloride (hereinafter, also referred to as TPC):

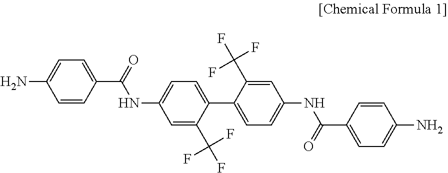 [SMILES: Nc1ccc(C(=O)Nc2ccc(-c3ccc(NC(=O)c4ccc(N)cc4)cc3C(F)(F)F)c(C(F)(F)F)c2)cc1]

According to an exemplary embodiment, a polyamideimide including a structural unit derived from an aromatic diamine including the compound represented by Chemical Formula 1 (hereinafter, also referred to as AB-TFMB), a structural unit derived from an aromatic diacid dichloride including terephthaloyl dichloride (hereinafter, also referred to as TPC), and a structural unit derived from a dianhydride is provided. The polyamideimide resin includes AB-TFMB and TPC, thereby providing both excellent mechanical properties and excellent optical properties.

Without being restricted to a certain theory, AB-TFMB may include a plurality of amide bonds in a molecule and an amide group may be further derived depending on a reaction of AB-TFMB and TPC. Accordingly, a plurality of amide bonds are included in the resin, thereby increasing an intramolecular interaction and/or an intermolecular interaction of an amide bond to greatly improve mechanical properties.

In addition, without being restricted to a certain theory, both AB-TFMB and TPC include an aromatic ring, for example, a benzene ring, thereby increasing a carbon content of the resin. Accordingly, a film having better mechanical properties and sufficient optical properties may be provided.

Though a method of preparing the resin is not particularly limited, for example, the aromatic diamine and the TPC may be reacted to prepare an oligomer having an amide end, which may then be reacted with the aromatic diamine and/or the dianhydride to prepare the polyamideimide resin. Accordingly, the resin further includes an amide bond (—NHCO—) derived from AB-TFMB as well as an amide group present at the end of the oligomer, thereby obtaining a polyamideimide resin having more improved optical properties and mechanical properties.

As another example of preparing the resin, a method of preparing a resin having a polyamideimide structure by reacting the aromatic diamine, TPC, and the dianhydride at the same time without a process of preparing the oligomer as described above may be included, but preferably, the process of preparing the oligomer described above is included to provide a film having better mechanical properties.

A specific preparation method of the polyamideimide resin will be described in the following.

As the aromatic diamine, AB-TFMB represented by Chemical Formula 1 is used alone, or aromatic diamines commonly used in the art are mixed as required.

Here, (the structural unit derived from) AB-TFMB may be included at 50 mol % or less, for example, 40 mol % or less, for example, 30 mol % or less, for example, 25 mol % or less, for example, 20 mol % or less, or for example, 15 mol % or less, based on total moles of (the structural unit derived from) the aromatic diamine, but the present invention is not limited thereto. In addition, (the structural unit derived from) AB-TFMB may be included at 3 mol % or more, for example, 5 mol % or more, based on total moles of (the structural unit derived from) AB-TFMB and (the structural unit derived from) the aromatic diamine, but the present invention is not limited thereto. When (the structural unit derived from) AB-TFMB is included in the above range, mechanical properties and optical properties may be better.

Hereinafter, the compound represented by Chemical Formula 1 may be a first aromatic diamine, and as an example, the aromatic diamine may further include a second aromatic diamine which is different from the compound represented by Chemical Formula 1.

As an example, the second aromatic diamine may include a substituted or unsubstituted C6 to C30 aromatic ring, in which the aromatic ring may be a single ring; a fused ring in which two or more aromatic rings are fused; or a non-fused ring in which two or more aromatic rings are connected by a single bond, a C1 to C5 alkylene group, or O or C(═O).

As an example, the second aromatic diamine may be a compound to which a fluorine substituent is introduced and by using the aromatic diamine to which the fluorine substituent is introduced, the polyamideimide resin may provide better optical properties. In addition, the aromatic diacid dichloride, specifically, terephthaloyl dichloride (TPC) are used together, thereby providing a higher total light transmittance, a low haze, a low yellow index, and excellent mechanical properties.

Specifically, the second aromatic diamine may include an aromatic ring substituted with one or two or more trifluoroalkyl groups, and for example, the aromatic ring substituted with a trifluoroalkyl group may be unsubstituted or further substituted with substituents other than the trifluoroalkyl group.

More specifically, the second aromatic diamine may include 2,2′-bis(trifluoromethyl)-benzidine (hereinafter, also referred to as TFMB), but is not limited thereto.

As an example, the aromatic diamine may be the compound represented by Chemical Formula 1 (AB-TFMB) alone or a mixture of the compound represented by Chemical Formula 1 and 2,2′-bis(trifluoromethyl)-benzidine (TFMB). Here, though a mixing ratio thereof is not limited, AB-TFMB may be included at for example, 50 mol % or less, for example, 40 mol % or less, for example, 30 mol % or less, for example, 25 mol % or less, for example, 20 mol % or less, or for example, 15 mol % or less, based on total moles of AB-TFMB and TFMB, but the present invention is not limited thereto. In addition, AB-TFMB may be included at 3 mol % or more, for example, 5 mol % or more with respect to total moles of AB-TFMB and TFMB, but is not limited thereto. When the mixing ratio of AB-TFMB and TFMB is in the above range, mechanical properties and optical properties may be better.

The aromatic diacid dichloride may be terephthaloyl dichloride (TPC) alone or a mixture of TPC and a known aromatic diacid dichloride.

Specifically, for example, a mixture of two or more selected from the group consisting of isophthaloyl dichloride (IPC), [1,1′-biphenyl]-4,4′-dicarbonyl dichloride (BPC), 1,4-naphthalene dicarboxylic dichloride (NPC), 2,6-naphthalene dicarboxylic dichloride (NTC), 1,5-naphthalene dicarboxylic dichloride (NEC), and derivatives thereof may be used, but the present invention is not limited thereto.

When an amide structure in a polymer chain is formed by the aromatic diacid dichloride, in particular, not only optical properties are improved, but also mechanical strength such as a modulus may be more improved.

As an example, in order to improve the mechanical properties of the film, more specifically, in order to satisfy the physical properties of a modulus in accordance with ASTM D882 of 6 GPa or more, (the structural unit derived from) the aromatic diacid dichloride may be included at 50 mol or more, 55 mol or more, 60 mol or more, and more specifically 50 mol to 100 mol with respect to 100 mol of (the structural unit derived from) the aromatic diamine.

More specifically, the aromatic diacid dichloride may be terephthaloyl dichloride (TPC) alone, and the content of (the structural unit derived from) the terephthaloyl dichloride may be mol or more, 55 mol or more, 60 mol or more, and more specifically 50 mol to 100 mol with respect to 100 mol of (the structural unit derived from) the aromatic diamine.

The polyamideimide resin described above includes the structural unit derived from the aromatic diacid dichloride in the range described above together with AB-TFMB, thereby not only further increasing the mechanical properties such as a modulus but also reducing the increase in a retardation in a thickness direction or deterioration of optical properties, and even when the resin is applied to a window cover film of a flexible display, screen distortion may be decreased. More specifically, as described above, AB-TFMB which has good rigidity and includes an amide bond (—NHCO—) is used together with TPC, thereby providing a film satisfying all physical properties of a modulus of 6 GPa or more, a total light transmittance of 87% or more as measured at 400 to 700 nm in accordance with ASTM D1003, a haze in accordance with ASTM D1003 of 2.0% or less, and a yellow index in accordance with ASTM E313 of 5 or less, as desired.

In addition, if necessary, the aromatic diacid dichloride may be a mixture of isophthaloyl dichloride (IPC) and terephthaloyl dichloride (TPC).

The dianhydride may include any one or two or more selected from the group consisting of aromatic dianhydrides and cycloaliphatic dianhydrides.

The aromatic dianhydriderefers to a dianhydride containing at least one aromatic ring, and the aromatic ring may be a single ring; a fused ring in which two or more aromatic rings are fused; or a non-fused ring in which two or more aromatic rings are connected by a single bond, a substituted or unsubstituted C1 to C5 alkylene group, or O or C(═).

Specifically, the aromatic dianhydride may include a dianhydride including a benzene ring, a non-fused ring in which two or more benzene rings are connected by a single bond, a non-fused ring in which two or more benzene rings are connected by a methylene group substituted with one or more trifluoromethyl groups, or a combination thereof.

More specifically, the aromatic dianhydride may include 4,4′-hexafluoroisopropylidene diphthalic anhydride (6FDA), biphenyltetracarboxylic dianhydride (BPDA), 9,9-bis(3,4-dicarboxyphenyl)fluorene dianhydride (BPAF), oxydiphthalic dianhydride (ODPA), sulfonyl diphthalic anhydride (SO2DPA), (isopropylidenediphenoxy) bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis(carboxylphenyl) dimethyl silane dianhydride (SiDA), and bis(dicarboxyphenoxy) diphenyl sulfide dianhydride (BDSDA), but is not limited thereto.

As an example, the aromatic dianhydride may include 4,4′-hexafluoroisopropylidene diphthalic anhydride (6FDA), biphenyltetracarboxylic dianhydride (BPDA), or a combination thereof, and for example, the aromatic dianhydride may include 4,4′-hexafluoroisopropylidene diphthalic anhydride (6FDA), but is not limited thereto, and if necessary, may further include the aromatic dianhydride described above.

The cycloaliphatic dianhydride refers to a dianhydride containing at least one substituted or unsubstituted C3 to C60 aliphatic ring, and the substituted or unsubstituted C3 to C60 aliphatic ring includes a substituted or unsubstituted C3 to C60 cycloalkane, substituted or unsubstituted C3 to C60 cycloalkene, or a combination thereof.

Specifically, the cycloaliphatic dianhydride may include dianhydrides including substituted or unsubstituted cyclobutane, substituted or unsubstituted cyclopentane, substituted or unsubstituted cyclohexane, substituted or unsubstituted cycloheptane, substituted or unsubstituted cyclooctane, substituted or unsubstituted cyclobutene, substituted or unsubstituted cyclopentene, substituted or unsubstituted cyclohexene, substituted or unsubstituted cycloheptene, substituted or unsubstituted cyclooctene, or a combination thereof.

More specifically, the cycloaliphatic dianhydride may include 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclo[2.2.2]oct-7-ene-2,3,5,6-tetracarboxylic dianhydride (BTA), bicyclooctene-2,3,5,6-tetracarboxylic dianhydride (BODA), 1,2,3,4-cyclopentanetetracarboxylic dianhydride (CPDA), 1,2,4,5-dianhydride cyclohexanetetracarboxylic dianhydride (CHDA), 1,2,4-tricarboxy-3-methylcarboxycyclopentane dianhydride (TMDA), 1,2,3,4-tetracarboxycyclopentane dianhydride(TCDA), or a combination thereof, but is not limited thereto.

As an example, the cycloaliphatic dianhydride may include 1,2,3,4-cyclobutanetetracarboxylic dianhydride (CBDA), but is not limited thereto, and if necessary, may further include the cycloaliphatic dianhydride described above.

As an example, the dianhydride may include one or two or more aromatic dianhydrides and one or two or more cycloaliphatic dianhydrides, in which the aromatic dianhydride and the cycloaliphatic dianhydride may be as described above.

More specifically, an exemplary embodiment of the present invention is a polyamideimide resin including: a structural unit derived from an aromatic diamine, a structural unit derived from an aromatic diacid dichloride, and a structural unit derived from a dianhydride,

wherein the aromatic diamine may include AB-TFMB of Chemical Formula 1,

the aromatic diacid dichloride may include terephthaloyl dichloride (TPC), and

the dianhydride may include any one or two or more compounds selected from the group consisting of aromatic dianhydrides and cycloaliphatic dianhydrides. Here, the aromatic dianhydride and the cycloaliphatic dianhydride are as described above.

More specifically, for example, as a non-limiting example, a first embodiment of the present invention is a polyamideimide resin including a structural unit derived from an aromatic diamine, a structural unit derived from an aromatic diacid dichloride, and a structural unit derived from a dianhydride,

wherein the aromatic diamine may include AB-TFMB,

the aromatic diacid dichloride may include TPC, and

the dianhydride may include an aromatic dianhydride which is any one selected from 4,4′-hexafluoroisopropylidene diphthalic anhydride (6-FDA) and biphenyltetracarboxylic dianhydride (BPDA) or a mixture thereof.

A second embodiment of the present invention is a polyamideimide resin including: a structural unit derived from an aromatic diamine, a structural unit derived from an aromatic diacid dichloride, and a structural unit derived from a dianhydride,

wherein the aromatic diamine may include AB-TFMB,

the aromatic diacid dichloride may include TPC, and

the dianhydride may include a cycloaliphatic dianhydride including 1,2,3,4-cyclobutanetetracarboxylic dianhydride.

A third embodiment of the present invention is a polyamideimide resin including: a structural unit derived from an aromatic diamine, a structural unit derived from an aromatic diacid dichloride, and a structural unit derived from a dianhydride,

wherein the aromatic diamine may include AB-TFMB,

the aromatic diacid dichloride may include TPC, and

the dianhydride may include an aromatic dianhydride which is any one selected from 4,4′-hexafluoroisopropylidene diphthalic anhydride (6-FDA) and biphenyltetracarboxylic dianhydride (BPDA) or a mixture thereof, and a cycloaliphatic dianhydride including 1,2,3,4-cyclobutanetetracarboxylic dianhydride.

A fourth embodiment of the present invention is a polyamideimide resin including: a structural unit derived from an aromatic diamine, a structural unit derived from an aromatic diacid dichloride, and a structural unit derived from a dianhydride,

wherein the aromatic diamine may include 2,2′-bis(trifluoromethyl)-benzidine (TFMB) and AB-TFMB,

the aromatic diacid dichloride may include TPC, and

the dianhydride may include an aromatic dianhydride which is any one selected from 4,4′-hexafluoroisopropylidene diphthalic anhydride (6-FDA) and biphenyltetracarboxylic dianhydride (BPDA) or a mixture thereof.

A fifth embodiment of the present invention is a polyamideimide resin including: a structural unit derived from an aromatic diamine, a structural unit derived from an aromatic diacid dichloride, and a structural unit derived from a dianhydride,

wherein the aromatic diamine may include 2,2′-bis(trifluoromethyl)-benzidine (TFMB) and AB-TFMB,

the aromatic diacid dichloride may include TPC, and

the dianhydride may include a cycloaliphatic dianhydride including 1,2,3,4-cyclobutanetetracarboxylic dianhydride.

A sixth embodiment of the present invention is a polyamideimide film including: a structural unit derived from an aromatic diamine, a structural unit derived from an aromatic diacid dichloride, and a structural unit derived from a dianhydride,

wherein the aromatic diamine may include 2,2′-bis(trifluoromethyl)-benzidine (TFMB) and AB-TFMB,

the aromatic diacid dichloride may include TPC, and

the dianhydride may include an aromatic dianhydride which is any one selected from 4,4′-hexafluoroisopropylidene diphthalic anhydride (6-FDA) and biphenyltetracarboxylic dianhydride (BPDA) or a mixture thereof, and a cycloaliphatic dianhydride including 1,2,3,4-cyclobutanetetracarboxylic dianhydride.

The first to sixth embodiments described above are only illustrative for more specifically describing one embodiment of the present invention, and the present invention is not limited thereto.

As an example, an equivalent ratio of (the structural unit derived from) the aromatic diamine to the sum of (the structural unit derived from) the aromatic diacid dichloride and (the structural unit derived from) the dianhydride may be 1:0.9 to 1.1, for example, 1:0.95 to 1.05, for example, 1:0.99 to 1.01, and for example, more preferably, close to 1:1. When the range is satisfied, the physical properties of a film including film formation properties when molding the film from the polyamideimide resin may be further improved.

As an example, (the structural unit derived from) the aromatic diamine may be included more than (the structural unit derived from) the dianhydride.

As an example, (the structural unit derived from) the aromatic diamine may be more included than (the structural unit derived from) the aromatic diacid dichloride.

As an example, 5 to 80 mol of (the structural unit derived from) the dianhydride may be included and 20 to 80 mol of (the structural unit derived from) the aromatic diacid dichloride may be included, based on 100 mol of (the structural unit derived from) the aromatic diamine; specifically, 30 to 80 mol of (the structural unit derived from) the dianhydride may be included and 30 to 70 mol of (the structural unit derived from) the aromatic diacid dichloride may be included, based on 100 mol of (the structural unit derived from) the aromatic diamine; and more specifically, 40 to 65 mol of (the structural unit derived from) the dianhydride may be included and 35 to 60 mol of (the structural unit derived from) the aromatic diacid dichloride may be included, based on 100 mol of (the structural unit derived from) the aromatic diamine.

More specifically, the polyamideimide resin may include (the structural unit derived from) the aromatic diamine, (the structural unit derived from) the aromatic dianhydride, (the structural unit derived from) the cycloaliphatic dianhydride, and (the structural unit derived from) the aromatic diacid dichloride. In this case, 5 to 50 mol of (the structural unit derived from) the aromatic dianhydride, 5 to 30 mol of (the structural unit derived from) the cycloaliphatic dianhydride, and 50 to 80 mol of (the structural unit derived from) the aromatic diacid dichloride may be included, based on 100 mol of (the structural unit derived from) the aromatic diamine.

Within the range, a film satisfying both a modulus and optical properties to be desired may be provided. The content range is an example for satisfying the physical properties to be desired and may be changed by the composition of a monomer, but is not limited thereto.

As an example, a weight average molecular weight of the polyamideimide resin is not particularly limited, but may be 200,000 g/mol or more, for example, 250,000 g/mol or more, and for example, 300,000 g/mol or more, and also, for example, 500,000 g/mol or less, for example, 400,000 g/mol or less, and more specifically, 250,000 to 400,000 g/mol. Accordingly, better mechanical properties and better dynamic bending properties which do not cause cracks even when repeated bending is applied may be provided.

As an example, a glass transition temperature of the polyamideimide resin is not limited, but may be 300 to 400° C., and more specifically 330 to 380° C.

Accordingly, a film having a high modulus, excellent mechanical strength, excellent optical properties, and less curling may be provided, but the present invention is not necessarily limited to the ranges.

According to another exemplary embodiment, a polyamideimide resin composition including the polyamideimide resin described above and a solvent is provided.

As an example, the solvent may be an organic solvent, specifically, a polar solvent, and more specifically, any one or two or more selected from the group consisting of N,N-dimethylacetamide (DMAc), N-methyl-2-pyrrolidone (NMP), dimethylformamide (DMF), methyl sulfoxide (DMSO), ethyl cellosolve, methyl cellosolve, acetone, ethyl acetate, m-cresol, gamma-butyrolactone (GBL), and derivatives thereof, but is not limited thereto.

The polyamideimide resin composition may further include an additive, if necessary, in addition to the polyamideimide resin composition described above. The additive may be those for film formation properties, adhesiveness, optical properties, mechanical properties, flame retardancy, and the like, and for example, a flame retardant, an adhesion improver, inorganic particles, an antioxidant, a UV protector, and/or a plasticizer, but is not limited thereto.

According to another exemplary embodiment, a polyamideimide resin film including the polyamideimide resin described above is provided.

As an example, the polyamideimide film may satisfy all of the physical properties of a modulus of 6 GPa or more, a total light transmittance of 87% or more as measured at 400 to 700 nm in accordance with ASTM D1003, a haze in accordance with ASTM D1003 of 2.0% or less, and a yellow index in accordance with ASTM E313 of 5 or less.

More specifically, it is preferred that the polyamideimide film satisfies all of the physical properties of a modulus of 6 GPa or more, 7 GPa or more, or specifically 6 to 10 GPa, a total light transmittance of 87% or more, 88% or more, or 89% or more as measured at 400 to 700 nm in accordance with ASTM D1003, a haze in accordance with ASTM D1003 of 2.0% or less, 1.5% or less, or 1.0% or less, and a yellow index in accordance with ASTM E313 of 5 or less, 4 or less, or 3 or less.

As an example, the polyamideimide film may have a thickness of 1 to 500 μm, for example, 10 to 250 μm, and for example, 10 to 100 μm.

Hereinafter, methods of preparing the polyamideimide resin, the polyamideimide resin composition, and the polyamideimide film according to an exemplary embodiment of the present invention will be described in more detail.

In the present invention, the preparation method is not limited as long as a film satisfying all of the physical properties of a modulus of 6 GPa or more, a total light transmittance of 87% or more as measured at 400 to 700 nm in accordance with ASTM D1003, a haze in accordance with ASTM D1003 of 2.0% or less, and a yellow index in accordance with ASTM E313 of 5 or less is prepared, and the method described later is specifically illustrated as an example, and the method is not limited to the method described later as long as a film satisfying the physical properties.

The film of the present invention may be prepared by applying a “resin composition” including a polyamideimide-based resin and a solvent on a substrate, and then performing drying or drying and stretching. The film of the present invention may be prepared by a solution casting method.

More specifically, the film may be prepared by including: reacting an aromatic diamine, an aromatic diacid dichloride, and any one or more dianhydrides selected from an aromatic dianhydride and a cycloaliphatic dianhydride to prepare a polyamic acid solution; imidizing the polyamic acid solution to prepare a polyamideimide resin; and applying a resin composition in which the polyamideimide resin is dissolved in an organic solvent to form a film.

Otherwise, the film may be prepared by including: reacting an aromatic diamine, an aromatic diacid dichloride, an aromatic dianhydride, and a cycloaliphatic dianhydride to prepare a polyamic acid solution; imidizing the polyamic acid solution to prepare a polyamideimide resin; and applying a resin composition in which the polyamideimide resin is dissolved in an organic solvent to form a film.

First, the case of preparing the polyamic acid solution is described.

The polyamic acid solution is a solution of the monomers described above, and includes an organic solvent for a polymerization reaction in a solution. The kind of organic solvent is not largely limited, and as an example, may be any one or two or more polar solvents selected from the group consisting of dimethylacetamide (DMAc), N-methyl-2-pyrrolidone (NMP), dimethylformamide (DMF), methyl sulfoxide (DMSO), ethyl cellosolve, methyl cellosolve, acetone, ethyl acetate, m-cresol, gamma-butyrolactone (GBL), and derivatives thereof.

In order to prepare the polyamic acid, the monomers described above may be polymerized at the same time, or the aromatic diamine and the aromatic diacid dichloride may be reacted to prepare an oligomer having an amine end and then the oligomer, an additional aromatic diamine, and a dianhydride may be reacted to prepare the polyamic acid solution. When the oligomer is prepared and then further polymerized, a block type polyamideimide is prepared and the mechanical properties of the film may be further improved.

A step of preparing an oligomer may include reacting an aromatic diamine and an aromatic diacid dichloride and purifying the obtained oligomer and performing drying. In this case, the aromatic diamine may be introduced at a mole ratio of 1.01 to 2 with respect to the aromatic diacid dichloride to prepare an amine terminated polyamide oligomer. The molecular weight of the oligomer is not particularly limited, but for example, the weight average molecular weight may be 1,000 to 3,000 g/mol.

Next, a step of preparing a polyamic acid solution may be performed by a solution polymerization reaction in which the thus-prepared oligomer is reacted with a fluorine-based aromatic diamine and a dianhydride in an organic solvent.

Next, the thus-prepared polyamic acid is imidized to prepare a polyamideimide resin. It may be performed by chemical imidization, and the imidization may be performed by further including any one or two or more selected from an imidization catalyst and a dehydrating agent.

As the imidization catalyst, any one or two or more selected from pyridine, isoquinoline, β-quinoline, and the like may be used. In addition, as the dehydrating agent, any one or two or more selected from an acetic anhydride, a phthalic anhydride, a maleic anhydride, and the like may be used, but the present invention is not necessarily limited thereto.

In addition, an additive such as a flame retardant, an adhesion improver, inorganic particles, an antioxidant, a UV inhibitor, and a plasticizer may be mixed with the polyamic acid solution to prepare the polyamideimide resin.

In addition, after the imidization, the resin is purified using a solvent to obtain a solid content, which may be dissolved in a solvent to obtain a polyamideimide resin composition (resin composition). The solvent may include, for example, N,N-dimethyl acetamide (DMAc) and the like, but is not limited thereto.

The step of forming a film using the polyamideimide resin composition is applying the polyamideimide resin composition on a substrate and then performing heat treatment to form a film.

As the substrate, for example, glass, stainless steel, a film, or the like may be used, but the present invention is not limited thereto. Application may be carried out by a die coater, an air knife, a reverse roll, a spray, a blade, casting, gravure, spin coating, and the like.

It is preferred that the heat treatment is carried out stepwise as an example. Preferably, the heat treatment may be carried out stepwise at 80 to 100° C. for 1 minute to 2 hours, at 100 to 200° C. for 1 minute to 2 hours, or at 250 to 300° C. for 1 minute to 2 hours. More preferably, the stepwise heat treatment depending on each temperature range is carried out for 30 minutes to 2 hours. Here, it is more preferred to perform the stepwise heat treatment by heating in a range of preferably 1 to 20° C./min when moving to each step. In addition, the heat treatment may be performed in a separate vacuum oven, an oven filled with inert gas, or the like, but the present invention is not necessarily limited thereto. In addition, a film may be formed by application on a substrate using an applicator.

The present invention may manufacture various forms of molded articles using the polyamideimide. As an example, the present invention may be applied to a printed wiring board, a flexible circuit board, and the like including a film, a protective film, or an insulating film, but the present invention is not limited thereto. Preferably, the present invention may be applied to a protective film which may replace cover glass, and has a wide application range in various industrial fields including a display.

More specifically, a window cover film such as a flexible display may be used.

<Functional Coating Layer>

According to an exemplary embodiment of the present invention, the functional coating layer is a layer for imparting functionality of the polyamideimide film according to an exemplary embodiment of the present invention film, and may be variously applied depending on the purpose.

Specifically, for example, the functional coating layer may include any one or more layers selected from an antistatic layer, an anti-fingerprint layer, an anti-fouling layer, an anti-scratch layer, an anti-reflective layer, and a shock absorption layer, but is not limited thereto.

The thickness of the functional coating layer is not limited, but may be 1 to 500 μm, more specifically 2 to 450 μm.

<Flexible Display Panel>

In an exemplary embodiment of the present invention, the polyamideimide film according to the exemplary embodiment, a window cover film including the same, a flexible display panel, or a flexible display device may be provided.

Here, the window cover film may be used as an outermost surface window substrate of the flexible display device. The flexible display device may be various image display devices such as a common liquid crystal display device, an electroluminescent display device, a plasma display device, and a field emission display device.

The display device including the window cover film of the present invention described above has excellent display quality and significantly decreased distortion by light, thereby minimizing a user's eye strain with excellent visibility.

Hereinafter, examples will be provided for specifically describing the present invention, but the present invention is not limited to the examples below.

Measurement Method

The physical properties of the present invention were measured as follows:

[1] Weight Average Molecular Weight

Measurement was performed by dissolving a film in a DMAc eluent containing 0.05 M LiCl. Waters GPC system, Waters 1515 isocratic HPLC Pump, and Waters 2414 Refractive Index detector were used as GPC, Olexis, Polypore and a mixed D column were connected as a column, and polymethylmethacrylate (PMMA STD) was used as a standard material. Analysis was performed at 35° C. at a flow rate of 1 mL/min.

[2] Modulus and Elongation at Break

Measurement was performed using UTM 3365 available from Instron, under the condition of pulling a polyamideimide film having a length of 50 mm and a width of 10 mm at 50 mm/min at 25° C.

The thickness of the film was measured and the value was input to the instrument. The unit of the modulus was GPa and the unit of the elongation at break was %. Measurement was performed in accordance with ASTM D882.

[3] Light Transmittance

Measurement was performed in accordance with the standard of ASTM D1003. A light transmittance meter (Nippon Denshoku, COH-5500) was used to measure total light transmittances of films prepared in each example and comparative example in the entire wavelength range of 400 to 700 nm. The unit was %.

[4] Haze

Measurement was performed using a spectrophotometer (from Nippon Denshoku, COH-5500) in accordance with the standard of ASTM D1003. The unit was %

[5] Yellow index (YI)

Measurement was performed using a spectrophotometer (from Nippon Denshoku, COH-5500) in accordance with the standard of ASTM E313.

### Example 1

<Preparation of Polyamideimide Resin Composition>

N,N-dimethylacetamide (DMAc) and 2,2′-bis(trifluoromethyl)-benzidine (TFMB) were added to a reactor under a nitrogen atmosphere with the composition described in the following Table 1, stirring was sufficiently performed, terephthaloyl dichloride (TPC) was added thereto, and stirring was performed for 6 hours to perform dissolution and reaction.

Thereafter, a reaction product obtained by using excessive water to perform precipitation and filtration was dried under vacuum at 90° C. for 6 hours or more to obtain an oligomer.

N,N-dimethylacetamide (DMAc), the oligomer, and additional 2,2′-bis(trifluoromethyl)-4,4′-bis(4-aminobenzoyl amino)biphenyl (AB-TFMB) and 2,2′-bis(trifluoromethyl)-benzidine (TFMB) were added to the reactor again under a nitrogen atmosphere so that the aromatic diamine is 100 mol, cyclobutane tetracarboxylic dianhydride (CBDA) and 4,4′-hexafluoroisopropylidene diphthalic anhydride (6FDA) were sequentially added at the mole ratio as shown in the following Table 1, and stirring was performed at 40° C. for 12 hours to perform dissolution and reaction to prepare a polyamic acid resin composition. Here, the amount of each monomer was as shown in the composition ratio in the following Table 1, a solid content was adjusted to 10 wt %, and a temperature of the reactor was maintained at 40° C.

Subsequently, each of pyridine and acetic anhydride was added sequentially at 2.5-fold relative to the total content of dianhydride, and stirring was performed at 60° C. for 12 hours to prepare a composition including a polyamideimide resin. The polyamideimide resin had a weight average molecular weight of 310,000 g/mol.

<Preparation of Film>

The composition including the polyamideimide resin was solution-cast on a glass substrate using an applicator. Thereafter, first drying was performed in a drying oven at 90° C. for 30 minutes, heat treatment was performed in a curing oven at 280° C. for 30 minutes under a N₂ condition, cooling to room temperature was performed, and a film formed on the glass substrate was separated from the substrate to obtain a polyamideimide film.

The physical properties of the thus-prepared film were measured, and are shown in the following Table 2.

### Examples 2 to 10

<Preparation of Polyamideimide Resin Composition>

The films were prepared in the same manner as in Example 1, except that the mole ratios were changed as shown in the following Table 1. The weight average molecular weights of the thus-prepared polyamideimide resins are shown in the following Table 1.

<Preparation of Film>

The films were prepared in the same manner as in Example 1, and the physical properties of the prepared films were measured and are shown in the following Table 2.

### Examples 11 and 12

<Preparation of Polyamideimide Resin Composition>

N,N-dimethylacetamide (DMAc) and AB-TFMB were added to a reactor under a nitrogen atmosphere with the composition described in the following Table 1, stirring was sufficiently performed, terephthaloyl dichloride (TPC) was added thereto, and stirring was performed for 6 hours to perform dissolution and reaction.

Thereafter, a reaction product obtained by using excessive water to perform precipitation and filtration was dried under vacuum at 90° C. for 6 hours or more to obtain an oligomer.

N,N-dimethylacetamide (DMAc), the oligomer, and additional 2,2′-bis(trifluoromethyl)-4,4′-bis(4-aminobenzoyl amino)biphenyl (AB-TFMB) were added to the reactor again under a nitrogen atmosphere so that the aromatic diamine is 100 mol, cyclobutane tetracarboxylic dianhydride (CBDA) and 4,4′-hexafluoroisopropylidene diphthalic anhydride (6FDA) were sequentially added at the mole ratio as shown in the following Table 1, and stirring was performed at 40° C. for 12 hours to perform dissolution and reaction to prepare a polyamic acid resin composition. Here, the amount of each monomer was as shown in the composition ratio in the following Table 1, a solid content was adjusted to 10 wt %, and a temperature of the reactor was maintained at 40° C.

Subsequently, each of pyridine and acetic anhydride was added sequentially at 2.5-fold relative to the total content of dianhydride, and stirring was performed at 60° C. for 12 hours to prepare a composition including a polyamideimide resin. The weight average molecular weight of the polyamideimide resin is as shown in the following Table 1.

<Preparation of Film>

The films were prepared in the same manner as in Example 1, and the physical properties of the prepared films were measured and are shown in the following Table 2.

### Comparative Examples 1 to 5

Polyamideimide resins and films were prepared in the same manner as in Example 1, except that the mole ratios were changed as shown in Table 1.

In Comparative Example 5, the oligomer prepared in Example 1, and additional 2,2′-bis(trifluoromethyl)-benzidine (TFMB) were added so that the aromatic diamine is 100 mol, 4,4′-hexafluoroisopropylidene diphthalic anhydride (6FDA), and biphenyltetracarboxylic dianhydride (BPDA) were sequentially added at the mole ratio as shown in the following Table 1, and stirring was performed at 40° C. for 12 hours to perform dissolution and reaction to prepare a polyamic acid resin composition. Here, the amount of each monomer was as shown in the composition ratio in the following Table 1, a solid content was adjusted to 10 wt %, and a temperature of the reactor was maintained at 40° C. The rest is the same as in Example 1.

The physical properties of the prepared resins are shown in the following Table 1, and the physical properties of the films are shown in the following Table 2.

TABLE 1

| | Composition (mole ratio) | | | | | | |
|---|---|---|---|---|---|---|---|
| Classi- | | AB- | | | | | Mw |
| fication | TFMB | TFMB | TPC | 6FDA | CBDA | BPDA | (g/mol) |
| Example | 90 | 10 | 55 | 15 | 30 | — | 310,000 |
| 1 | | | | | | | |
| Example | 80 | 20 | 55 | 15 | 30 | — | 330,000 |
| 2 | | | | | | | |
| Example | 80 | 20 | 55 | 10 | 35 | — | 320,000 |
| 3 | | | | | | | |
| Example | 77 | 23 | 55 | 15 | 30 | — | 300,000 |
| 4 | | | | | | | |
| Example | 85 | 15 | 60 | 15 | 25 | — | 290,000 |
| 5 | | | | | | | |
| Example | 50 | 50 | 35 | 15 | 50 | — | 380,000 |
| 6 | | | | | | | |
| Example | 50 | 50 | 35 | 20 | 45 | — | 350,000 |
| 7 | | | | | | | |
| Example | 90 | 10 | 35 | — | 65 | — | 300,000 |
| 8 | | | | | | | |
| Example | 70 | 30 | 50 | 15 | 35 | — | 330,000 |
| 9 | | | | | | | |
| Example | 90 | 10 | 35 | 15 | 50 | — | 320,000 |
| 10 | | | | | | | |
| Example | — | 100 | 55 | 15 | 30 | — | 370,000 |
| 11 | | | | | | | |
| Example | — | 100 | 55 | 45 | — | — | 350,000 |
| 12 | | | | | | | |
| Com- | — | 100 | — | 15 | 85 | — | 340,000 |
| parative | | | | | | | |
| Example | | | | | | | |
| 1 | | | | | | | |
| Com- | 100 | — | 55 | 15 | 30 | — | 330,000 |
| parative | | | | | | | |
| Example | | | | | | | |
| 2 | | | | | | | |
| Com- | 100 | — | — | 80 | 20 | — | 290,000 |
| parative | | | | | | | |
| Example | | | | | | | |
| 3 | | | | | | | |
| Com- | 50 | 50 | — | 80 | 20 | — | 300,000 |
| parative | | | | | | | |
| Example | | | | | | | |
| 4 | | | | | | | |
| Com- | 100 | — | 55 | 20 | — | 25 | 320,000 |
| parative | | | | | | | |
| Example | | | | | | | |
| 5 | | | | | | | |

TABLE 2

| | | | | | Mechanical | |
|---|---|---|---|---|---|---|
| | | Optical | | | properties | |
| | Thick- | properties | | | | Elongation |
| Classi- | ness | Tt | Haze | | Modulus | at break |
| fication | (μm) | (%) | (%) | YI | (GPa) | (%) |
| Example 1 | 49 | 90.19 | 0.31 | 2.95 | 7.48 | 18.5 |
| Example 2 | 48 | 89.75 | 0.53 | 3.53 | 7.78 | 19.3 |
| Example 3 | 48 | 89.2 | 0.74 | 4.16 | 7.97 | 12.3 |
| Example 4 | 53.1 | 89.45 | 0.64 | 4.17 | 7.68 | 26.3 |
| Example 5 | 52.8 | 89.34 | 1.5 | 4.61 | 7.16 | 13.9 |
| Example 6 | 47 | 88.68 | 0.78 | 4.9 | 9.23 | 13.1 |
| Example 7 | 48 | 88.97 | 0.65 | 4.72 | 8.6 | 15.2 |
| Example 8 | 47 | 88.45 | 1.84 | 4.89 | 7.37 | 12.1 |
| Example 9 | 47 | 89.35 | 0.64 | 3.92 | 8.33 | 17.2 |
| Comparative | 52.2 | 88.4 | 0.41 | 9.08 | 6.8 | 8.4 |
| Example 1 | | | | | | |
| Comparative | 50 | 90.5 | 0.34 | 2.7 | 6.9 | 15.9 |
| Example 2 | | | | | | |
| Comparative | 48 | 91.3 | 0.4 | 1.7 | 4.03 | 14.6 |
| Example 3 | | | | | | |
| Comparative | 49 | 89.8 | 0.53 | 4.1 | 5.9 | 13.5 |
| Example 4 | | | | | | |
| Comparative | 51 | 90.3 | 0.3 | 4.6 | 5.8 | 15.9 |
| Example 5 | | | | | | |

Evaluation 1. Evaluation of Film Formation Properties

The thicknesses of the polyamideimide films prepared from the polyamideimide resins according to the examples and the comparative examples were measured with a thin film thickness gauge (μ-bite from TESA) three times, respectively, and the average values are shown in Table 1.

It was confirmed that the polyamideimide films prepared from the polyamideimide resins of Examples 1 to 12 were able to form films having a sufficient thickness to be used as a flexible window cover film.

Evaluation 2. Evaluation of Mechanical Properties

The modulus and the elongation at break of the polyamideimide films prepared from the polyamideimide resins of the examples and the comparative examples were measured by the measurement methods described above, and the results are shown in Table 2.

Referring to Table 2, the polyamideimide films prepared from the polyamideimide resins of the examples had a high modulus of 7 GPa or more while maintaining an elongation at break equivalent to or higher than the polyamideimide films prepared from the polyamideimide resins of the comparative examples, and thus, were confirmed to have excellent mechanical properties.

Evaluation 3. Evaluation of Optical Properties

The light transmittance, the haze, and the yellow index of the polyamideimide films prepared from the polyamideimide resins of the examples and the comparative examples were measured by the measurement methods described above, and the results are shown in Table 2.

Referring to Table 2, the polyamideimide films prepared from the polyamideimide resins of the examples all had a total light transmittance of 87% or more as measured at 400 to 700 nm in accordance with ASTM D1003, a haze in accordance with ASTM D1003 of 2.0% or less, and a yellow index in accordance with ASTM E313 of 5 or less. Therefore, it was confirmed that the polyamideimide films prepared from the polyamideimide resins of the examples had sufficient optical properties to be used as a flexible window cover film and had optical properties better than or equivalent to the polyamideimide films prepared from the polyamideimide resins of the comparative examples.

In summary, the polyamideimide resins of the examples may form a polyamideimide film having a sufficient thickness to be applied as a window cover film for a flexible display, and the polyamideimide film may show excellent mechanical properties while maintaining excellent optical properties.

Hereinabove, although the present invention has been described by specific exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1. A polyamideimide resin comprising:
a structural unit derived from an aromatic diamine, a structural unit derived from an aromatic diacid dichloride, and a structural unit derived from a dianhydride,
wherein the aromatic diamine comprises a compound represented by the following Chemical Formula 1, and
the aromatic diacid dichloride comprises terephthaloyl dichloride:

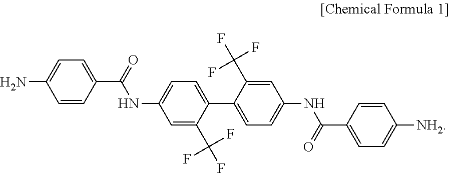 [SMILES: Nc1ccc(C(=O)Nc2ccc(-c3ccc(NC(=O)c4ccc(N)cc4)cc3C(F)(F)F)c(C(F)(F)F)c2)cc1]

2. The polyamideimide resin of claim 1, wherein
the aromatic diamine further comprises a second aromatic diamine which is different from the compound represented by Chemical Formula 1.

3. The polyamideimide resin of claim 2, wherein
the second aromatic diamine comprises an aromatic ring substituted with a trifluoroalkyl group.

4. The polyamideimide resin of claim 2, wherein
the second aromatic diamine comprises 2,2′-bis(trifluoromethyl)-benzidine.

5. The polyamideimide resin of claim 1, wherein
the dianhydride comprises any one or two or more selected from the group consisting of aromatic dianhydrides and cycloaliphatic dianhydrides.

6. The polyamideimide resin of claim 5, wherein
the dianhydride comprises one or two or more aromatic dianhydrides and one or two or more cycloaliphatic dianhydrides.

7. The polyamideimide resin of claim 5, wherein
the aromatic dianhydride comprises 4,4′-hexafluoroisopropylidene diphthalic anhydride, biphenyltetracarboxylic dianhydride, or a combination thereof.

8. The polyamideimide resin of claim 5, wherein
the cycloaliphatic dianhydride comprises 1,2,3,4-cyclobutanetetracarboxylic dianhydride.

9. The polyamideimide resin of claim 1, wherein
the structural unit derived from the compound represented by Chemical Formula 1 is comprised at 50 mol % or less, based on total moles of the structural unit derived from the aromatic diamine.

10. The polyamideimide resin of claim 1, wherein
the structural unit derived from the aromatic diacid dichloride is comprised at 50 mol % or more, based on 100 moles of the structural unit derived from the aromatic diamine.

11. The polyamideimide resin of claim 1, wherein
an equivalent ratio of the structural unit derived from the aromatic diamine to a sum of the structural unit derived from the aromatic diacid dichloride and the structural unit derived from the dianhydride is 1:0.9 to 1.1.

12. The polyamideimide resin of claim 1, wherein
the polyamideimide resin has a weight average molecular weight of 200,000 g/mol or more.

13. A polyamideimide resin composition comprising the polyamideimide resin of claim 1.

14. A polyamideimide film comprising the polyamideimide resin of claim 1.

15. The polyamideimide film of claim 14, wherein
the polyamideimide film has a modulus of 6 GPa or more.

16. The polyamideimide film of claim 14, wherein
the polyamideimide film has a total light transmittance of 87% or more as measured at a wavelength of 400 to 700 nm in accordance with ASTM D1003, a haze in accordance with ASTM D1003 of 2.0% or less, and a yellow index in accordance with ASTM E313 of 5 or less.

17. The polyamideimide film of claim 14, wherein
the polyamideimide film has a thickness of 1 to 500 μm.

18. A window cover film comprising the polyamideimide film of claim 14.

19. The window cover film of claim 18, wherein
the window cover film has any one or more coating layers selected from a hard coating layer, an antistatic layer, an anti-fingerprint layer, an antifouling layer, an anti-scratch layer, a low-refractive layer, an anti-reflective layer, and a shock absorption layer on at least one surface of the polyamideimide-based film.

20. A flexible display panel comprising the polyamideimide film of claim 14.
